(19) United States
(12) Patent Application Publication
(10) Pub. No.: US 2004/0142115 A1
(43) Pub. Date: Jul. 22, 2004

(54) Coating agent

(76) Inventors: Thomas Jaworek, Kallstadt (DE); Reinhold Schwalm, Wachenheim (DE); Rainer Koniger, Mannheim (DE); Erich Beck, Ladenburg (DE); Martin Weber, Maikammer (DE); Falko Ramsteiner, Ludwigshafen (DE); Andreas Pfau, Ludwigshafen (DE); Wolfgang Schrof, Neuleiningen (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/250,692

(22) PCT Filed: Jan. 3, 2002
(86) PCT No.: PCT/EP02/00019

(30) Foreign Application Priority Data
Jan. 4, 2001 (DE) 10100170.3

(51) Int. Cl. B05D 3/02

(52) U.S. Cl. 427/508; 427/385.5

(57) ABSTRACT

The present invention relates to a process for producing a coating substrate by applying at least one coating composition to the substrate and then curing it to give a coating film on the substrate, to the coated substrates obtained by this process, and to a coating composition.

The present invention relates to a process for producing a coated substrate by applying at least one coating composition to the substrate and then curing to give a coating film on the substrate, to the coated substrates obtained by this process, and to a coating composition.

In industry nowadays there is increasing use of polymer-based moldings which are used, where appropriate, together with metal components, and which require coating. This applies in particular to automotive components, which are increasingly being manufactured from plastics parts: examples are bumper linings, spoilers, sills, wheelarch linings, and side trims or protection strips.

Plastics are generally sensitive to the effects of weathering, such as UV radiation and moisture, and when exposed in this way exhibit a variety of problems such as yellowing, embrittlement or cracking, unless appropriate precautionary measures are taken. In order to avoid these problems it is known, for example, to provide plastics that are exposed to the effects of weathering as a consequence of their use as exterior automotive components with clearcoats or topcoats.

Besides the weathering stability already mentioned, the coating materials used are intended at the same time to exhibit good adhesion to the plastics substrates and to lead to a hydrolysis-resistant composite (i.e., good adhesion following moisture exposure) having good chemical resistance and good strength at room temperature, which exhibits ductile fracture behavior even at low temperatures of −20 to −30° C. The latter is a problem in particular when very hard and mar-resistant topcoats are to be used, whose brittleness affects the mechanical behavior of the underlying plastics substrate as well.

In the field of the coating of plastics furthermore, an additional requirement is that the coating compositions used be curable at low temperatures (generally <100° C.) and lead to films having the desired properties even when cured at these low temperatures. The clearcoat may be used as the sole coating film, or may form the topmost coat of a multicoat topcoat system. Coating compositions of this kind are also suitable in principle as clearcoats in automotive OEM finishing and refinish, in industrial coating, including coil coating and container coating, or in furniture coating.

Suitable materials for the clearcoat or topcoat include the customary and known one-component (1K), two-component (2K), multicomponent (3K, 4K), powder or powder slurry clearcoat materials or UV-curable clearcoat materials. One-component (1K), two-component (2K) or multicomponent (3K, 4K) clearcoat materials are described, for example, in U.S. Pat. No. 5,474,811, U.S. Pat. No. 5,356,669, U.S. Pat. No. 5,605,965, WO 94/10211, WO 94/10212, WO 94/10213, EP-A-0 594 068, EP-A-0 594 071, EP-A-0 594 142, EP-A-0 604 992, WO 94/22969, EP-A-0 596 460, and WO 92/22615.

Powder clearcoat materials are known, for example, from DE-A-42 22 194.

A powder coating material which is curable thermally and with high-energy radiation is described in EP-A-0 844 286. It comprises an unsaturated binder and a second resin, which is copolymerizable with the binder, and also a photoinitiator and a thermal initiator, and is therefore curable thermally and with high-energy radiation. However, this dual-cure powder coating material is used as a pigmented topcoat material, which is cured with UV light at the surface and is cured thermally in the regions close to the substrate.

Powder slurry coating materials are powder coating materials in the form of aqueous dispersions. Slurries of this kind are described, for example, in U.S. Pat. No. 4,268,542, DE-A-195 18 392, and DE-A-196 13 547.

UV-curable clearcoat materials are described, for example, in EP-A-0 540 884, EP-A-0 568 967 and U.S. Pat. No. 4,675,234.

Each of these clearcoat materials is still in need of improvement. Thus, although these clearcoat materials can generally be used to obtain multicoat paint systems which satisfy the optical requirements, the mar-resistant one-component (1K) clearcoats are not sufficiently stable to weathering whereas the weathering-stable two-component (2K) or multicomponent (3K, 4K) clearcoats are often not sufficiently mar-resistant. Some one-component (1K) clearcoats are both mar-resistant and weathering-stable, but in combination with commonly employed aqueous basecoat materials exhibit surface defects such as shrinkage (wrinkling).

Powder clearcoat materials, powder slurry clearcoat materials, and UV-curable clearcoat materials, on the other hand, generally have an intercoat adhesion which is not entirely satisfactory, nor do they fully solve the problems of mar resistance or etch resistance.

EP-A-0 568 967 discloses a process for producing multicoat paint systems by applying a thermally curable clearcoat film by the wet-on-wet technique to a pigmented basecoat film and then subjecting the two films to a conjoint thermal cure. Atop the cured clearcoat film there is subsequently applied at least one further clearcoat film, based on coating materials curable with actinic radiation, and this second film is cured with actinic radiation, or with actinic radiation and thermally. This process gives clearcoat finishes of high chemical resistance and optical quality. The mar resistance, however, is unsatisfactory.

Moreover, EP-A-0 568 967 describes a process in which a coating material curable with actinic radiation is applied to the pigmented basecoat film and cured. Then a further film of the same material is applied and is cured with actinic radiation. Although this gives a high-gloss surface without perceptible texture, the clearcoat finish in question yellows. The mar resistance, too, is in need of improvement.

The hydrolysis and condensation of silane compounds provides what are known as sol-gel clearcoat materials based on siloxane coating formulations. Such coating materials, which are used as coating compositions for coatings on plastics, are described, for example, in DE-A-43 03 570, DE-A-34 07 087, DE-A-40 11 045, DE-A-40 25 215, DE-A-38 28 098, DE-A-40 20 316 and DE-A-41 22 743. Sol-gel clearcoat materials of this kind impart very good mar resistance to the surfaces of substrates made of plastic, such as spectacle lenses or motobike helmet visors. This mar resistance is not achieved by the known OEM (original equipment manufacturing) clearcoat materials commonly used for the original finish of vehicles.

It is desirable to transfer this improved mar resistance to the clearcoat films that are used for the finishing of automobiles. The intention in particular is to provide better protection to those parts of the automobile bodies that are subjected particularly to severe stresses, such as hoods, bumpers, sills or doors in the region of the door handles.

Replacing the OEM clearcoat materials with OEM powder slurry clearcoat materials commonly used in automotive finishing by sol-gel clearcoat materials is not a straightforward matter, however, since the sol-gel coats are too brittle for this purpose, for example, or since the attempt to conform them to the OEM requirements frequently provides only poor optical properties (appearance). Furthermore, sol-gel clearcoat materials cannot be applied in thicknesses >8 to 10 μm. Moreover, constituents of the sol-gel clearcoat materials may strike through in the course of their drying and/or curing; that is, they are absorbed by the substrate, as a result of which the clearcoat films in question lose hardness. Additionally, the sol-gel clearcoat materials are too expensive for these applications.

The economically more favorable use of the sol-gel clearcoat materials as an additional coating film over the clearcoat materials used to date leads in turn to adhesion problems within the multicoat clearcoat system, between the clearcoat and the sol-gel coat. These problems are manifested in particular following stone chipping and on exposure to condensation. In some cases, this problem is exacerbated further by the adhesion between the clearcoat and the substrate also being affected by the sol-gel coating.

It is an object of the present invention to provide a process for producing coated substrates which, in the form of a single-coat or multicoat film, avoids the disadvantages of the prior art. Thus the coatings are preferably to have a profile of properties which combines as many as possible of the following: the coatings are easier to prepare, highly mar resistant, stable to weathering, free from yellowing, hard, flexible and/or free from surface defects. Preferably they ought to exhibit a high level of adhesion to a large number of different substrates and also within the coating system. Specifically, they should have no substantial adverse effect on the mechanical properties of the substrate and should be able to be produced in the high film thickness required for an excellent overall appearance.

We have found that this object is achieved by a process for producing a coated substrate in which a coating composition is applied to the substrate and then cured and an inconstancy (a gradient) in at least one chemical and/or physical property is induced and fixed in the coating composition.

The invention provides a process for producing a coated substrate by applying at least one coating composition to the substrate and then curing to obtain a coating film on the substrate, which comprises inducing and fixing in the coating composition a gradient in at least one chemical and/or physical property, substantially perpendicularly to the substrate surface.

Preferably, the property exhibiting the gradient is selected from the crosslinking density, network arc length, network tension, microhardness, free volume, and combinations thereof. The gradient (the inconstancy) may be detected, for example, by means of confocal Raman microscopy, as described by W. Schroof, E. Beck, R. Königer, W. Reich and R. Schwalm in Progress in Organic Coatings, 35 (1999), 197-204.

Advantageously, the property gradient is detected, for example, by means of scanning atomic force microscopy. Following preparation of film sections of the coated substrates of the invention, the areas of section may be investigated using the method described by F. N. Jones et al., in Progress in Organic Coatings 34 (1998) 119-129: Studies of microhardness and mar resistance using a scanning probe microscope, in order to determine the microhardness.

The gradient may also be advantageously detected by means of 2-photon microscopy in order to determine the free volume of the polymer film. In order to determine the free volume in a cured coating film, a fluorescent dye may be added to it prior to application. The fluorescent dye should be selected such that, where curing is by UV exposure, the dye does not detract from the cure. After the film has cured, the fluorescent dyes used show a wavelength shift which is dependent on the free volume in the matrix (the cured coating composition). 2-Photon microscopy permits spatially dependent determination of the free volume with high lateral and depth-dependent resolution. This method is based on that described by R. Propielarz, D. C. Neckers, Proceedings, RadTech 1996, North America, Intern. UV/EB Processing Conference, 1996, pp. 271-277, by which the free volume is determined in transmitted light, i.e., integrally over the whole film.

In one first embodiment of the process of the invention, the gradient is induced during application of the coating composition to the substrate and is fixed during cure. This can be done by applying the coating composition to the substrate in accordance, for example, with a gradient flow coating process with a time variation in the amount of diluent.

In another preferred embodiment of the process of the invention, the gradient is induced following application of the coating composition to the substrate and is fixed during cure. For this purpose, the coating composition may comprise components, or be applied in such a way, that following application the gradient is induced by means of diffusion effects.

In another preferred embodiment, the gradient is induced and fixed during cure.

In the process of the invention it is preferred to use a coating composition which can be cured by at least two different mechanisms.

Particularly preferred coating compositions are those which can be cured with actinic radiation, such as UV radiation and electron beams, and thermally.

For the purposes of this specification, curing is the transition of the coating composition from a state which is necessary for application and/or flow to a solid state which has coatings properties. In this context it is unnecessary for the curing of the coating composition by one curing mechanism to be sufficient alone to give the typical profile of coatings properties such as hardness, mar resistance and/or chemical resistance.

In one preferred embodiment, at least two curing methods are combined to give a coating which has the ultimate desired profile of properties. In this case, one of the two curing methods is preferably directed in such a way that the resulting coating film exhibits the gradient in one or more chemical and/or physical properties. The effect of the inventively induced gradient is that the coating has the resistance, in the face of mechanical and environmental influences, that is required of a coating surface. The induced inconstancy in one or more chemical and/or physical properties generally also has the effect of permitting good adhesion of the coating film to the substrate. Furthermore, the induced gradient makes it possible to obtain intercoats in one or more coats of a multicoat paint system, and to reduce the influence exerted on the mechanical properties of the plastics substrate by a hard and brittle topcoat in such a way that the mechanical performance properties of the coated component are retained.

Examples of suitable curing methods are the drying and/or evaporation of the solutions and dispersions of the coating composition, thermal curing, oxidative curing, or curing by means of high-energy (actinic) radiation, especially UV radiation, and combinations thereof. In the case of curing by two different mechanisms, particular preference is given to thermal curing as the first cure. A second cure may be effected by one of the cure methods described, for example, by varying the exposure time or by relatively high temperatures or relatively high radiation intensities and/or using different wavelength ranges of the radiation. The second cure preferably comprises curing by exposure to high-energy radiation, especially curing by UV radiation.

In the context of the present invention, the term thermal curing embraces both external crosslinking and self-crosslinking. That form of the thermal curing of a film of a coating composition comprising a separate crosslinking agent is referred to as external crosslinking. In contrast, where the coating composition already incorporates the components that bring about crosslinking, this is referred to as self-crosslinking. In accordance with the invention, external crosslinking is of advantage.

In the context of the present invention, curing by UV radiation preferably means a cure initiated by free-radical or cationic photoinitiators.

In the process of the invention it is preferred to use a coating composition comprising

A) at least one compound containing at least two functional groups which are capable of reaction with a complementary functional group of a compound of component B) under conditions of thermal cure,

B) at least one compound containing at least two functional groups which are capable of reacting with a complementary functional group of a compound of component A) under conditions of thermal cure,

C) if desired, at least one compound having two C═C double bonds curable with UV radiation in the presence of a photoinitiator,

D) at least one photoinitiator,

E) if desired, at least one compound capable of forming free radicals thermally,

F) if desired, at least one reactive diluent, other than the compounds of components A) to C) which is capable of crosslinking under conditions of thermal cure,

G) if desired, at least one reactive diluent, other than the compounds of components A) to C) and F), which is capable of crosslinking with UV radiation,

H) if desired, nanoparticles,

I) at least one coating additive which is capable of inducing the gradient during cure, and

K) if desired, further customary coating additives other than compounds of component I),

with the proviso that at least one compound of components A) and/or B) additionally contains at least one UV-curable C═C double bond or the coating composition mandatorily includes at least one compound of component C).

In the context of the present invention, “complementary functional groups” mean a pair of functional groups which are able to react with one another under the conditions of the thermal cure. Preferably, the complementary functional groups react with one another in a condensation or addition reaction. “Complementary compounds” are pairs of compounds which contain mutually complementary functional groups.

Preferred complementary functional groups of the compounds of components A) and B) are selected from the complementary functional groups a and b of the overview below, in which R and R′ are organic groups, such as alkyl, preferably C₁-C₂₀ alkyl, such as methyl, ethyl, n-propyl, isopropyl, n-butyl, tert-butyl, the isomeric pentyls, hexyls, heptyls, octyls etc.; cycloalkyl, preferably C₅-C₈ cycloalkyl, especially cyclopentyl and cyclohexyl; aryl, preferably phenyl; hetaryl etc., and in which R′ may also be hydrogen.

Overview: Examples of complementary functional groups a and b

| Component A | Component B |
|---|---|
| Functional group a | Functional group b |
| —SH | —C(O)—OH |
| —NH₂ | —C(O)—O—C(O)— |
| OH | —NCO |
| | —NH—C(O)—OR |
| | —NH—CH₂—OH |
| | —NH—CH₂—O—CH₃ |
| | —NH—C(O)—CH(—C(O)OR)(—C(O)—R) |
| | —NH—C(O)—CH(—C(O)OR)₂ |
| | —NH—C(O)—NR′₂ |
| | ═Si(OR)₂ |
| | epoxy |
| —C(O)—OH | epoxy |
| —O—C(O)—CR′═CH₂ | —OH |
| —O—CR′═CH₂ | —NH₂ |
| | —C(O)—CH₂—C(O)—R |
| | —CH═CH₂ |

Functional groups suitable for forming complementary pairs are preferably selected from hydroxyl, primary and secondary amino, thiol, carboxylic acid, carboxylic ester, carboxamide, carboxylic anhydride, sulfonic acid, sulfonic ester, isocyanate, blocked isocyanate, urethane, urea, ether, and epoxy groups.

Pairs suitable for reaction are, for example, on the one hand compounds having active hydrogen atoms, selected for example from compounds containing alcohol, primary and secondary amine, and thiol groups, and on the other hand compounds having groups reactive therewith, selected for example from carboxylic acid, carboxylic ester, carboxamide, carboxylic anhydride, isocyanate, urethane, urea, alcohol, ether and epoxy groups. A further suitable pair comprises, for example, compounds containing epoxy groups, on the one hand, and carboxylic acid groups, on the other. It is generally not critical which functional group of the pair carries the compound A) and which the compound B).

The complementary functional groups a and b are preferably selected such that substantially they do not enter into any reactions initiated by actinic radiation and/or do not disrupt or inhibit the curing of actinic radiation described below. With preference, the complementary functional groups a and b are further selected in accordance with the temperature at which the thermal cure is to take place. In this context it may be of advantage, especially with respect to thermally sensitive substrates such as plastics, to choose a temperature that does not exceed 100° C. and in particular does not exceed 80° C. In view of these boundary conditions, it is preferred to use hydroxyl groups (OH) and isocyanate groups (NCO) as complementary functional groups a and b.

The compounds of components A and/or B may further contain at least one further functional group, c, which is suitable for crosslinking with actinic radiation. Examples of suitable functional groups c are epoxy groups or olefinically unsaturated double bonds, such as are present in vinyl, allyl, cinnamoyl, methacryloyl or acryloyl group, particularly methacryloyl or acryloyl groups. For curing by cationic photopolymerization, it is preferred to use epoxy groups c. For free-radical photopolymerization, preference is given to using olefinically unsaturated double bonds c. In accordance with the invention, the functional group(s) a and/or b may also be (a) epoxy group(s), which is (are) then suitable for the thermal cure and for the actinic radiation cure. It is preferred to use exclusively olefinically unsaturated double bonds as functional groups c.

In addition to the components A and B, the coating composition may comprise at least one further component C containing at least two functional groups c which are amenable to crosslinking with actinic radiation. Where neither component A nor component B contains a functional group c, the coating composition mandatorily includes a component C.

In the context of the present invention, preferably, components A, B and C are substantially oligomeric compounds which in general contain on average from 2 to 15 repeating unit structures or monomer units. In the present case, a polymeric compound is a compound containing in general on average at least 16 repeating unit structures or monomer units. Compounds of this kind are also referred to as binders or resins.

In the context of the present invention, a low molecular mass compound is a compound derived substantially from only one unit structure or one monomer unit. Compounds of this kind are also generally referred by those in the art as reactive diluents (components F) and G)).

Component A preferably comprises resins. Examples of suitable oligomer or polymer classes are α-functional acrylates, methacrylates, polyesters or polyethers. Particular preference is given to the corresponding hydroxy-functional oligomers and/or polymers.

Component A may also be at least one oligomeric or polymeric compound containing, if desired, at least one, preferably at least two, and in particular at least three, hydroxyl group(s) and/or other other abovementioned groups a, and at least two, and in particular three, (meth)acryloyl groups and/or other groups c.

Component A is used preferably in an amount of from 5 to 90% by weight, with particular preference from 10 to 80% by weight, and in particular from 15 to 70% by weight, based in each case on the overall amount of the total composition.

The coating composition generally further comprises a component B containing at least one, preferably at least two, and in particular at least three, functional groups b which are amenable to thermal curing in combination with the functional group a of component A. Examples of suitable functional groups of this kind may be taken from the above overview. Isocyanate groups are particularly preferred functional groups b here. Particular advantages result if the resins B have an isocyanate group b content of from 7 to 20% by weight, with particular preference from 8 to 18% by weight, and in particular from 9 to 17% by weight, based in each case on the resin B. Examples of suitable resins B of the kind described above are described, for example, in U.S. Pat. No. 5,234,970, EP-A-0 549 116 or EP-A-0 618 244.

The isocyanate group may be free or in blocked form. Examples of suitable diisocyanates and/or polyisocyanates for preparing the coating composition B or for preparing the blocked derivatives are organic polyisocyanates, especially those known as paint polyisocyanates, containing free isocyanate groups attached to aliphatic, cycloaliphatic, araliphatic and/or aromatic moieties. It is preferred to use polyisocyanates containing from 2 to 5 isocyanate groups per molecule. They preferably have viscosities of from 100 to 10 000, more preferably from 100 to 5 000, and in particular from 100 to 2 000, mPas (at 23° C.). If desired, small amounts of organic solvents, preferably from 1 to 25% by weight, based on straight polyisocyanate, may be added to the polyisocyanates in order thereby to improve the ease of incorporation of the isocyanate and, where appropriate, to lower the viscosity of the polyisocyanate to a level within the abovementioned ranges. Examples of suitable solvent additives to the polyisocyanates are ethoxyethyl propionate, amyl methyl ketone, and butyl acetate. Moreover, the polyisocyanates may have been subjected to conventional hydrophilic or hydrophobic modification.

Examples of suitable polyisocyanates are described in “Methoden der organischen Chemie”, Houben-Weyl, Volume 14/2, 4th Edition, Georg Thieme Verlag, Stuttgart 1963, pp. 61-70, and in W. Siefken, Liebigs Annalen der Chemie, Volume 562, pp. 75-136. Also suitable are polyurethane prepolymers containing isocyanate groups, which may be prepared by reacting polyols with an excess of polyisocyanates.

Further examples of suitable polyisocyanates are polyisocyanates containing isocyanurate, biuret, allophanate, iminooxadiazinedione, urethane, urea and/or uretdione groups. Polyisocyanates containing urethane groups, for example, are obtained by reacting some of the isocyanate groups with polyols, such as trimethylolpropane and glycerol, for example. Preference is given to using aliphatic or cycloaliphatic polyisocyanates, especially hexamethylene diisocyanate, dimerized and trimerized hexamethylene diisocyanate, isophorone diisocyanate, 2-isocyanatopropylcyclohexyl isocyanate, dicyclohexylmethane 2,4′-diisocyanate, dicyclohexylmethane 4,4′-diisocyanate or 1,3-bis(isocyanatomethyl)cyclohexane, diisocyanates derived from dimeric fatty acids, as sold under the commercial designation DDI 1410 by Henkel, 1,8-diisocyanato-4-isocyanatomethyloctane, 1,7-diisocyanato-4-isocyanatomethylheptane or 1-isocyanato-2-(3-isocyanatopropyl)cyclohexane, or mixtures of these polyisocyanates.

Particular preference is given to using mixtures of polyisocyanates that contain uretdione and/or isocyanurate and/or allophanate groups and are based on hexamethylene diisocyanate, as are formed by catalytic oligomerization of hexamethylene diisocyanate using appropriate catalysts. The polyisocyanate constituent may further comprise any desired mixtures of the free polyisocyanates exemplified.

Very particular preference is given to using mixtures of polyisocyanates that contain allophanate groups and are based on hexamethylene diisocyanates, as are formed by catalytic oligomerization of hexamethylene diisocyanates with appropriate catalysts, which additionally carry a functional group c which is curable by means of actinic radiation.

Examples of suitable blocking agents are the blocking agents known from U.S. Pat. No. 4,444,954. These include blocking agents such as

i) phenols such as phenol, cresol, xylenol, nitrophenol, chlorophenol, ethylphenol, t-butylphenol, hydroxybenzoic acid, esters of this acid, or 2,5-di-tert-butyl-4-hydroxytoluene;

ii) lactams, such as ε-caprolactam, δ-valerolactam, γ-butyrolactam or β-propiolactam;

iii) active methylenic compounds, such as diethyl malonate, dimethyl malonate, ethyl or methyl acetoacetate, or acetylacetone;

iv) alcohols such as methanol, ethanol, n-propanol, isopropanol, n-butanol, isobutanol, t-butanol, n-amyl alcohol, t-amyl alcohol, lauryl alcohol, ethylene glycol monomethyl ether, ethylene glycol monoethyl ether, ethylene glycol monobutyl ether, diethylene glycol monomethyl ether, diethylene glycol monoethyl ether, propylene glycol monomethyl ether, methoxymethanol, glycolic acid, glycolic esters, lactic acid, lactic esters, methylolurea, methylolmelamine, diacetone alcohol, ethylenechlorohydrin, ethylenebromohydrin, 1,3-dichloro-2-propanol, 1,4-cyclohexyldimethanol or acetocyanohydrin;

v) mercaptans such as butyl mercaptan, hexyl mercaptan, t-butyl mercaptan, t-dodecyl mercaptan, 2-mercaptobenzothiazole, thiophenol, methylthiophenol or ethylthiophenol;

vi) acid amides such as acetoanilide, acetoanisidinamide, acrylamide, methacrylamide, acetamide, stearamide or benzamide;

vii) imides such as succinimide, phthalimide or maleimide;

viii) amines such as diphenylamine, phenylnaphthylamine, xylidine, N-phenylxylidine, carbazole, aniline, naphthylamine, butylamine, dibutylamine or butylphenylamine;

ix) imidazoles such as imidazole or 2-ethylimidazole;

x) ureas such as urea, thiourea, ethyleneurea, ethylenethiourea or 1,3-diphenylurea;

xi) carbamates such as phenyl N-phenylcarbamate or 2-oxazolidone;

xii) imines such as ethyleneimine;

xiii) oximes such as acetone oxime, formaldoxime, acetaldoxime, acetoxime, methyl ethyl ketoxime, diisobutyl ketoxime, diacetyl monoxime, benzophenone oxime or chlorohexanone oximes;

xiv) salts of sulfurous acid such as sodium bisulfite or potassium bisulfite;

xv) hydroxamic esters such as benzyl methacrylohydroxamate (BMH) or allyl methacrylohydroxamate; or

xvi) substituted pyrazoles, ketoximes, imidazoles or triazoles; and also

xvii) mixtures of these blocking agents, especially dimethylpyrazole and triazoles, malonic esters and acetoacetic esters or dimethylpyrazole and succinimide.

As component B it is also possible to use tris(alkoxycarbonylamino)triazines of the formula

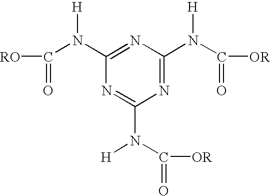

where the radicals R may be identical or different and are preferably alkyl of 1 to 8 carbon atoms, such as methyl, ethyl, n-propyl, isopropyl, n-butyl, tert-butyl, pentyl, hexyl, heptyl, and octyl.

Examples of suitable tris(alkoxycarbonylamino)triazines are described in U.S. Pat. No. 4,939,213, U.S. Pat. No. 5,084,541 or EP-A-0 624 577. Use is made in particular of the tris(methoxy-, tris(butoxy- and/or tris(2-ethylhexoxycarbonylamino)triazines. The methyl butyl mixed esters, the butyl 2-ethylhexyl mixed esters, and the butyl esters are of advantage. They have the advantage over the straight methyl ester of better solubility in polymer melts, and also have less of a tendency to crystallize out.

Especially suitable as component B are amino resins, examples being melamine resins. In this instance, use can be made of any amino resin suitable for transparent topcoats or clearcoats, or of a mixture of such amino resins. Especially suitable are the customary and known amino resins some of whose methylol and/or methoxymethyl groups have been defunctionalized by means of carbamate or allophanate groups. Crosslinking agents of this kind are described in U.S. Pat. No. 4,710,542 and EP-B-0 245 700 and also in the article by B. Singh and coworkers, “Carbamylmethylated Melamines, Novel Crosslinkers for the Coatings Industry” in Advanced Organic Coatings Science and Technology Series, 1991, Volume 13, pp. 193-207.

Furthermore, it is of advantage for the coating composition of the invention if the complementary functional groups a and b, especially hydroxyl groups and the isocyanate groups, the latter also in blocked form, are present in a molar ratio a:b (e.g., OH:NCO) of from 0.5:1 to 2:1, with preference from 0.8:1 to 1.5:1, in particular from 0.8:1 to 1.2:1, and with very particular preference from 0.8:1 to 1.0:1.

The polymers or oligomers used as component C normally have a number-average molecular weight of from 500 to 50 000, preferably from 1 000 to 5 000. Where, as in the particularly preferred case, vinylic double bonds are present, the coating composition has a double bond equivalent weight of from 400 to 2 000, with particular preference from 500 to 900. Furthermore, they have a viscosity at 23° C. of preferably from 250 to 11 000 mPas. They are present preferably in an amount of from 5 to 90% by weight, with particular preference from 10 to 80% by weight, and in particular from 15 to 70% by weight, based in each case on the overall weight of the coating composition.

Examples of suitable binders or resins C come from the oligomer and/or polymer classes of the (meth)acryloyl-functionalized (meth)acrylic copolymers, polyether acrylates, polyester acrylates, ethylenically unsaturated polyesters, epoxy acrylates, urethane acrylates, aminoalkyl acrylates, melamine acrylates, silicone acrylates and phosphazene acrylates and the corresponding methacrylates. It is preferred to use binders C which are free from aromatic structural units. Preference is therefore given to using urethane (meth)acrylates, phosphazene (meth)acrylates and/or polyester (meth)acrylates, with particular preference urethane (meth)acrylates, especially aliphatic urethane (meth)acrylates.

The urethane (meth)acrylates C are obtained by reacting a diisocyanate or polyisocyanate with a chain extender from the group of the diols/polyols and/or diamines/polyamines and/or dithiols/polythiols and/or alkanolamines and then reacting the remaining free isocyanate groups with at least one hydroxyalkyl (meth)acrylate or hydroxyalkyl ester of other ethylenically unsaturated carboxylic acids.

The amounts of chain extender, diisocyanate or polyisocyanate, and hydroxyalkyl ester in this case are preferably chosen so that

1.) the ratio of equivalents of the NCO groups to the reactive groups of the chain extender (hydroxyl, amino and/or mercapto groups) is in the range from 3:1 to 1:2, preferably 2:1, and

2.) the OH groups of the hydroxyalkyl esters of the ethylenically unsaturated carboxylic acids are stoichiometric with regard to the remaining free isocyanate groups of the prepolymer formed from isocyanate and chain extender.

Also suitable are urethane (meth)acrylates obtainable by first reacting some of the isocyanate groups of a diisocyanate or polyisocyanate with at least one hydroxyalkyl ester and then reacting the remaining isocyanate groups with a chain extender. In this case too the amounts of chain extender, isocyanate and hydroxyalkyl ester are chosen such that the ratio of equivalents of the NCO groups to the reactive groups of the chain extender is between 3:1 and 1:2, preferably 2:1, and the ratio of equivalents of the remaining NCO groups to the OH groups of the hydroxyalkyl ester is 1:1. All of the forms lying between these two processes are of course also possible. For example, some of the isocyanate groups of a diisocyanate may be reacted first of all with a diol, after which a further portion of the isocyanate groups may be reacted with the hydroxyalkyl ester, and, subsequently, the remaining isocyanate groups may be reacted with a diamine.

These various preparation processes for the urethane (meth)acrylates are known (c.f., for example, EP-A-204 161).

The urethane (meth)acrylates may be flexibilized, for example, by reacting corresponding isocyanate-functional prepolymers or oligomers with relatively long-chain aliphatic diols and/or diamines, especially aliphatic diols and/or diamines having at least 6 carbon atoms. This flexibilization reaction may be carried out before or after the addition of acrylic and/or methacrylic acid onto the oligomers and/or prepolymers.

Further examples which may be mentioned of suitable urethane (meth)acrylates C are the following, commercially available polyfunctional aliphatic urethane acrylates:

Crodamer® UVU 300 from Croda Resins Ltd., Kent, United Kingdom;

Genomer® 4302, 4235, 4297 or 4316 from Rahn Chemie, Switzerland;

Ebecryl® 284, 294, IRR351, 5129 or 1290 from UCB, Drogenbos, Belgium;

Roskydal® LS 2989 or LS 2545 or V94-504 from Bayer AG, Germany;

Viaktin® VTE 6160 from Vianova, Austria; or

Laromer® 8861 or Laromer LR 8987 from BASF AG,

and experimental products modified therefrom.

One example of a suitable polyphosphazene (meth)acrylate C is the phosphazene dimethacrylate from Idemitsu, Japan.

The coating composition for use in accordance with the invention may comprise at least one photoinitiator D, if the coating material is to be crosslinked using UV radiation. Where such initiators are used, they are present in the coating material in fractions of preferably from 0.1 to 10% by weight, more preferably from 1 to 8% by weight, and in particular from 2 to 6% by weight, based in each case on the overall amount of the coating material.

Examples of suitable photoinitiators are those of the Norrish II type, whose mechanism of action is based on an intramolecular variant of the hydrogen abstraction reactions as occur diversely in photochemical reactions (reference may be made here, by way of example, to Römpp Chemie Lexikon, 9th, expanded and revised edition, Georg Thieme Verlag Stuttgart, Vol. 4, 1991) or cationic photoinitiators (reference may be made here, by way of example, to Römpp Lexikon Lacke und Druckfarben, Georg Thieme Verlag Stuttgart, 1998, pp. 444-446), especially benzophenones, benzoins or benzoin ethers, or phosphine oxides.

It is also possible to use, for example, the products available commercially under the names Irgacure® 184, Irgacure® 1800 and Irgacure® 500 from Ciba Geigy, Genocure® MBF from Rahn, and Lucirin® TPO from BASF AG.

Besides the photoinitiators D, use may be made of customary sensitizers such as anthracene in effective amounts.

Furthermore, the coating composition may comprise one or more initiators E which, by forming free radicals, bring about thermal crosslinking. At from 80 to 120° C., these initiators form radicals which start the crosslinking reaction. Examples of thermolabile free-radical initiators are organic peroxides, organic azo compounds, or C—C-cleaving initiators, such as dialkyl peroxides, peroxocarboxylic acids, peroxodicarbonates, peroxide esters, hydroperoxides, ketone peroxides, azo dinitriles, or benzpinacol silyl ethers. Particularly preferred compounds E are C—C-cleaving initiators, since their thermal cleavage does not produce any gaseous decomposition products which might lead to defects in the coating film. Where compounds E are used, their amounts are generally from 0.1 to 10% by weight, preferably from 0.5 to 8% by weight, and in particular from 1 to 5% by weight, based in each case on the overall amount of the coating composition.

Examples of suitable thermally crosslinkable reactive diluents F are oligomeric polyols which are obtainable from oligomeric intermediates, themselves obtained by metathesis reactions of acyclic monoolefins and cyclic monoolefins, by hydroformylation and subsequent hydrogenation. Examples of suitable cyclic monoolefins are cyclobutene, cyclopentene, cyclohexene, cyclooctene, cycloheptene, norbornene or 7-oxanorbornene. Suitable acyclic monoolefins are present, for example, in hydrocarbon mixtures obtained in petroleum processing by cracking (C5 cut).

Suitable oligomeric polyols F preferably have a hydroxyl number (OHN) of from 200 to 450, a number-average molecular weight Mₙ Of from 400 to 1 000, and a mass-average molecular weight M_{w} of from 600 to 1 100.

Further examples of suitable thermally crosslinkable reactive diluents F are hyperbranched compounds having a tetrafunctional central group, derived from ditrimethylolpropane, diglycerol, ditrimethylolethane, pentaerythritol, tetrakis(2-hydroxyethyl)-methane, tetrakis(3-hydroxypropyl)methane or 2,2-bishydroxy-methyl-1,4-butanediol (homopentaerythritol). These reactive diluents may be prepared in accordance with the customary and known methods of preparing hyperbranched and dendrimeric compounds. Suitable synthesis methods are described, for example, in WO 93/17060 or WO 96/12754 or in the book by G. R. Newkome, C. N. Moorefield and F. Vögtle, “Dendritic Molecules, Concepts, Syntheses, Perspectives”, VCH, Weinheim, N.Y., 1996.

Further examples of suitable reactive diluents are polycarbonate diols, polyester polyols, poly(meth)acrylate diols or hydroxyl-containing polyaddition products.

Examples of suitable reactive solvents which may be used as reactive diluents F are butyl glycol, 2-methoxypropanol, n-butanol, methoxybutanol, n-propanol, ethylene glycol monomethyl ether, ethylene glycol monoethyl ether, ethylene glycol monobutyl ether, diethylene glycol monomethyl ether, diethylene glycol monoethyl ether, diethylene glycol diethyl ether, diethylene glycol monobutyl ether, trimethylolpropane, ethyl 2-hydroxypropionate or 3-methyl-3-methoxybutanol and also derivatives based on propylene glycol, e.g., ethoxyethyl propionate, isopropoxypropanol or methoxypropyl acetate.

The coating composition may further comprise minor amounts of at least one thermally curable constituent F1. In the context of the present invention, “minor amounts” are amounts which do not adversely affect the dual-cure properties of the coating material. Where they are used, their fraction in the coating material should generally not exceed 40% by weight, preferably 35% by weight, and in particular 30% by weight.

Examples of suitable constituents F1 are the crosslinking agents and binders that are known from the thermally curable coating materials.

Examples of suitable binders F1 are linear and/or branched and/or block, comb and/or random, poly(meth)acrylates or acrylate copolymers, polyesters, alkyds, amino resins, polyurethanes, polylactones, polycarbonates, polyethers, epoxy resin-amine adducts, (meth)acrylate diols, partially saponified polyvinyl esters or polyureas, of which the acrylate copolymers, the polyesters, the polyurethanes, the polyethers and the epoxy resin-amine adducts are advantageous.

Suitable binders F1 are sold, for example, under the tradenames Desmophen® 650, 2089, 1100, 670, 1200 or 2017 by Bayer, under the tradenames Priplas or Pripol® by Uniqema, under the tradenames Chempol® polyester or polyacrylate-polyol by CCP, under the tradenames Crodapol® 0-85 or 0-86 by Croda, or under the tradename Formrez® ER417 by Witco.

As reactive diluents G which may be crosslinked with actinic radiation, use is made, for example, of (meth)acrylic acid and esters, maleic acid and its esters, including monoesters, vinyl acetate, vinyl ethers, vinylureas, and the like. Examples that may be mentioned include alkylene glycol di(meth)acrylate, polyethylene glycol di(meth)acrylate, 1,3-butanediol di(meth)acrylate, vinyl (meth)acrylate, allyl (meth)acrylate, glycerol tri(meth)acrylate, trimethylolpropane tri(meth)-acrylate, trimethylolpropane di(meth)acrylate, styrene, vinyltoluene, divinylbenzene, pentaerythritol tri(meth)acrylate, pentaerythritol tetra(meth)acrylate, dipropylene glycol di(meth)acrylate, hexanediol di(meth)acrylate, ethoxyethoxy-ethyl acrylate, N-vinylpyrrolidone, phenoxyethyl acrylate, dimethylaminoethyl acrylate, hydroxyethyl (meth)acrylate, butoxyethyl acrylate, isobornyl (meth)acrylate, dimethylacrylamide and dicyclopentyl acrylate, and the long-chain linear diacrylates that are described in EP-A-250 631, having a molecular weight of from 400 to 4 000, preferably from 600 to 2 500. For example, the two acrylate groups may be separated by a polyoxybutylene structure. It is further possible to use 1,12-dodecyl diacrylate and the reaction product of 2 mols of acrylic acid with one mole of a dimeric fatty alcohol having generally 36 carbon atoms. Also suitable are mixtures of the abovementioned monomers.

Preferred reactive diluents G are mono- and/or diacrylates, such as isobornyl acrylate, hexanediol diacrylate, tripropylene glycol diacrylate, Laromer® 8887 from BASF AG and Actilane® 423 from Akcros Chemicals, Ltd., UK. Particularly preferred reactive diluents G are isobornyl acrylate, hexanediol diacrylate, and tripropylene glycol diacrylate.

Where used, the reactive diluents F and G are employed in an amount of preferably from 2 to 70% by weight, with particular preference from 10 to 65% by weight, and in particular from 15 to 50% by weight, based in each case on the overall amount of the coating composition.

A further constituent of the coating composition may consist of nanoparticles H, especially those based on silicon dioxide, aluminum oxide, and zirconium oxide. They have a particle size <50 nm and have no flatting effect. Preferably, nanoparticles based on aluminum oxide and zirconium oxide are used.

Examples of suitable nanoparticles H based on silicon dioxide are pyrogenic silicas, which are sold under the tradename Aerosil® VP8200, VP721 or R972 by Degussa or under the tradenames Cab O Sil® TS 610, CT 1110F or CT 1110G by CABOT.

In general, these nanoparticles are sold in the form of dispersions in monomers curable with actinic radiation, such as the reactive diluents G described above. Examples of suitable monomers which are especially suitable for the present application are alkoxylated pentaerythritol tetraacrylate or triacrylate, ditrimethylolpropane tetraacrylate or triacrylate, dineopentyl glycol diacrylate, trimethylolpropane triacrylate, trishydroxyethyl isocyanurate triacrylate, dipentaerythritol pentaacrylate or hexaacrylate or hexanediol diacrylate. In general, dispersions containing nanoparticles in an amount, based in each case on the dispersions, of from 10 to 80% by weight, preferably from 15 to 70% by weight, with particular preference from 20 to 60% by weight, and in particular from 25 to 50% by weight.

An example of a nanoparticle dispersion which is especially suitable in accordance with the invention is the dispersion sold under the tradename High Link® OG 103-31 by Clariant Hoechst.

The nanoparticle dispersions are present in the coating composition advantageously in an amount of from 2 to 30% by weight, with particular preference from 3 to 25% by weight, and in particular from 5 to 20% by weight, based in each case on the overall amount of the coating composition.

In the context of the present invention, it is preferred to use coating compositions which comprise a component I) apt to direct at least one of the cures in such a way that the coating film has a gradient (an inconstancy) in at least one chemical and/or physical property. Such functional additives are different than the customary coatings additives K).

Component I) is preferably selected from UV absorbers, colorless and colored pigments, and mixtures thereof.

The coating composition preferably comprises component I) in an amount of at least 1% by weight, with particular preference at least 3% by weight, in particular at least 5% by weight, and especially at least 7% by weight, based on the overall amount of components A) to K).

The influencing of the intensity of UV radiation by scattering or absorption by pigment or dye additives may take place, for example, through the Kubelka-Munk equation or a radiation equation derived from it. The application of the Kubelka-Munk equation is described, for example, by Z. W. Wicks Jr. and W. Kuhhirt in J. Paint Technol. 47 (1975) 49-59.

The coating composition may further comprise at least one customary and known coatings additive K) in effective amounts, i.e., in amounts preferably up to 20% by weight, with particular preference up to 15% by weight, and in particular up to 10% by weight, based in each case on the overall amount of the coating composition.

Examples of suitable coatings additives K are:

i) light stabilizers such as HALS compounds, benzotriazoles or oxalanilides;

ii) free-radical scavengers;

iii) crosslinking catalysts such as dibutyltin dilaurate or lithium decanoate;

iv) slip additives;

v) polymerization inhibitors;

vi) defoamers;

vii) emulsifiers, especially nonionic emulsifiers such as alkoxylated alkanols and polyols, phenols and alkylphenols or anionic emulsifiers such as alkali metal salts and ammonium salts of alkanecarboxylic acids, alkanesulfonic acids, and sulfonic acids of alkoxylated alkanols and polyols, phenols and alkylphenols;

viii) wetting agents such as siloxanes, fluorine compounds, carboxylic monoesters, phosphoric esters, polyacrylic acids and copolymers thereof, or polyurethanes;

ix) adhesion promoters such as tricyclodecanedimethanol;

x) leveling agents;

xi) film-forming auxiliaries such as cellulose derivatives;

xii) flame retardants or flatting agents.

Further examples of suitable coatings additives K are described in the textbook “Lackadditive” [Additives for coatings] by Johan Bieleman, Wiley-VCH, Weinheim, N.Y., 1998.

The coating composition used in the process of the invention may be present in different forms. For instance, given an appropriate choice of its constituents as described above, it may be present in the form of a liquid coating composition which is substantially free from organic solvents and/or water.

Alternatively, the coating material may comprise a solution or dispersion of the above-described constituents in water and/or organic solvents. Moreover, given an appropriate choice of its constituents as described above, the coating composition may be a powder clearcoat material. This powder clearcoat material may if desired be dispersed in water to give a powder slurry clearcoat material.

The coating composition, if permitted by the combination of its constituents with respect to the reactivity of the functional groups a, b and c, may be a one-component system. If, however, there is a risk of premature thermal crosslinking of the abovementioned constituents, it is advisable to configure the coating composition as a two-component or multicomponent system, in which at least the constituent B is stored separately from the other constituents and is not added to them until shortly before use.

The clearcoat film is applied in a wet film thickness such that curing in the finished clearcoat of the invention results in a dry film thickness of from 5 to 200, preferably from 10 to 100, with particular preference from 15 to 75, and in particular from 20 to 50 μm.

The application of the coating composition for the purpose of producing the clearcoat film may take place by any customary application method, such as spraying, knife coating, brushing, flow coating, dipping or rolling, for example. It is preferred to employ spray application methods, such as compressed air spraying, airless spraying, high-speed rotation, electrostatic spray application (ESTA), for example, alone or in conjunction with hot spray application such as hot air spraying, for example. Application may take place at temperatures of max. 70 to 80° C., so that appropriate application viscosities are attained without any change or damage to the coating composition and its overspray (which may be intended for reprocessing) during the short period of thermal stress. Hot spraying, for instance, may be configured in such a way that the coating composition is heated only very briefly in the spray nozzle or shortly before the spray nozzle.

The spray booth used for application may be operated, for example, with a circulation system, which may be temperature-controllable, and which is operated with an appropriate absorption medium for the overspray, an example of such a medium being the coating composition itself. Preferably, application is made under illumination with visible light with a wavelength of more than 550 mm, or in the absence of light. By this means, material alteration or damage to the coating composition and to the overspray is avoided.

The application methods described above may of course also be used to produce further coating films or the basecoat film as part of the production of a multicoat system. Different coating materials may be used to build up each of the different coats. Application to a basecoat film is preferred.

The coating or coating system of the invention is outstandingly suitable for coating a primed or unprimed substrate.

Suitable substrates include all surfaces to be coated that are amenable to a combined cure, examples of such surfaces being metals, plastics, wood, ceramics, stone, textiles, fiber composites, leather, glass, glass fibers, glass wool and rock wool, metal- and resin-bound building materials, such as plasterboard panels and cement slabs or roof tiles. Accordingly, the clearcoat of the invention is also suitable for applications outside of automotive finishing, in particular for the coating of furniture and for industrial coating, including coil coating and container coating.

The substrates used in accordance with the invention preferably comprise at least a natural or synthetic polymeric material.

Examples of materials of this type are:

1. Polymers of mono- and diolefins, for example polypropylene, polyisobutylene, poly-1-butene, poly-4-methyl-1-pentene, polyisoprene, and polybutadiene, and also polymers of cycloolefins, e.g. of cyclopentene or norbornene; also polyethylene (which may, where appropriate, have been crosslinked), e.g. high-density polyethylene (HDPE), high-density high-molecular-weight polyethylene (HDPE-HMW), high-density ultra-high-molecular-weight polyethylene (HDPE-UHMW), medium-density polyethylene (MDPE), low-density polyethylene (LDPE), linear low-density polyethylene (LLDPE), and branched low-density polyethylene (VLDPE).

2. Polyolefins, i.e. the monoolefin polymers mentioned by way of example in the section above, in particular polyethylene and polypropylene, may be prepared by various processes, in particular free-radical processes, or by way of a catalyst, the catalyst usually comprising one or more metals of group IVb, Vb, VIb, or VIII. These catalyst systems are usually termed Phillips, Standard Oil Indiana, Ziegler(-Natta), TNZ (DuPont), metallocene, or single-site catalysts (SSC).

3. Mixtures of the polymers mentioned in 1., e.g. mixtures of polypropylene with polyisobutylene, polypropylene with polyethylene (e.g. PP/HDPE, PP/LDPE), and mixtures of different polyethylene grades (e.g. LDPE/HDPE).

4. Copolymers of mono- and diolefins with one another or with other vinyl monomers, e.g. ethylene-propylene copolymers, linear low-density polyethylene (LLDPE), and mixtures of the same with low-density polyethylene (LDPE), propylene-1-butene copolymers, propylene-isobutylene copolymers, ethylene-1-butene copolymers, ethylene-hexene copolymers, ethylene-methylpentene copolymers, ethylene-heptene copolymers, ethylene-octene copolymers, propylene-butadiene copolymers, isobutylene-isoprene copolymers, ethylene-alkyl acrylate copolymers, ethylene-alkyl methacrylate copolymers, ethylene-vinyl acetate copolymers and copolymers of these with carbon monoxide, and ethylene-acrylic acid copolymers and salts of these (ionomers), and also terpolymers of ethylene with propylene and with a diene, such as hexadiene, dicyclopentadiene, or ethylidenenorbornene; also mixtures of these copolymers with one another, or with polymers mentioned in 1., e.g. polypropylene/ethylene-propylene copolymers, LDPE/ethylene-vinyl acetate copolymers, LDPE/ethylene-acrylic acid copolymers, LLDPE/ethylene-vinyl acetate copolymers, LLDPE/ethylene-acrylic acid copolymers, and alternating-structure or random-structure polyalkylene-carbon monoxide copolymers, and mixtures of these with other polymers, e.g. with polyamides.

5. Hydrocarbon resins, including hydrogenated modifications of these (e.g. tackifier resins), and mixtures of polyalkylenes and starch.

6. Polystyrene, poly(p-methylstyrene), poly(α-methylstyrene).

7. Copolymers of styrene or α-methylstyrene with dienes or with acrylic derivatives, e.g. styrene-butadiene, styrene-acrylonitrile, styrene-alkyl methacrylate, styrene-butadiene-alkyl acrylate, styrene-butadiene-alkyl methacrylate, styrene-maleic anhydride, styrene-acrylonitrile-methyl acrylate; mixtures with high impact strength made from styrene copolymers with another polymer, e.g. with a polyacrylate, with a diene polymer, or with an ethylene-propylene-diene terpolymer; and block copolymers of styrene, e.g. styrene-butadiene-styrene, styrene-isoprene-styrene, styrene-ethylene/butylene-styrene, and styrene-ethylene/propylene-styrene.

8. Graft copolymers of styrene or α-methylstyrene, e.g. styrene on polybutadiene, styrene on polybutadiene-styrene copolymers, styrene on polybutadiene-acrylonitrile copolymers, styrene and acrylonitrile (and, respectively, methacrylonitrile) on polybutadiene; styrene, acrylonitrile, and methyl methacrylate on polybutadiene; styrene and maleic anhydride on polybutadiene; styrene, acrylonitrile, and maleic anhydride or maleimide on polybutadiene; styrene and maleimide on polybutadiene, styrene and alkyl acrylates and, respectively, alkyl methacrylates on polybutadiene, styrene and acrylonitrile on ethylene-propylene-diene terpolymers, styrene and acrylonitrile on polyalkyl acrylates or on polyalkyl methacrylates, styrene and acrylonitrile on acrylate-butadiene copolymers, and also mixtures of these with the copolymers mentioned in 6, e.g. those known as ABS polymers, MBS polymers, ASA polymers, or AES polymers.

9. Halogen-containing polymers, e.g. polychloroprene, chlorinated rubber, chlorinated and brominated isobutylene-isoprene copolymer (halobutyl rubber), chlorinated or chlorosulfonated polyethylene, copolymers of ethylene with chlorinated ethylene, epichlorohydrin homo- and copolymers, and in particular polymers of halogen-containing vinyl compounds, e.g. polyvinyl chloride, polyvinylidene chloride, polyvinyl fluoride, polyvinylidene fluoride; and copolymers of these, such as vinyl chloride-vinylidene chloride, vinyl chloride-vinyl acetate, and vinylidene chloride-vinyl acetate.

10. Polymers derived from α, βunsaturated acids or from derivatives of these, for example polyacrylates and polymethacrylates, butyl-acrylate-impact-modified polymethyl methacrylates, polyacrylamides, and polyacrylonitriles.

11. Copolymers of the monomers mentioned in 10. with one another or with other unsaturated monomers, e.g. acrylonitrile-butadiene copolymers, acrylonitrile-alkyl acrylate copolymers, acrylonitrile-alkoxyalkyl acrylate copolymers, acrylonitrile-vinyl halide copolymers, and acrylonitrile-alkyl methacrylate-butadiene terpolymers.

12. Polymers derived from unsaturated alcohols or amines and, respectively, their acyl derivatives or acetals, for example polyvinyl alcohol, polyvinyl acetate, polyvinyl stearate, polyvinyl benzoate, polyvinyl maleate, polyvinyl butyral, polyallyl phthalate, polyallylmelamine; and copolymers of these with olefins mentioned in 1.

13. Homo- and copolymers of cyclic ethers, for example polyalkylene glycols, polyethylene oxide, polypropylene oxide, and copolymers of these with bisglycidyl ethers.

14. Polyacetals, such as polyoxymethylene, and polyoxymethylenes which contain comonomers, e.g. ethylene oxide; polyacetals modified with thermoplastic polyurethanes, with acrylates, or with MBS.

15. Polyphenylene oxides and polyphenylene sulfides, and mixtures of these with styrene polymers or with polyamides.

16. Polyurethanes derived, on the one hand, from polyethers, polyesters, or polybutadienes having terminal hydroxyl groups and, on the other hand, from aliphatic or aromatic polyisocyanates, and also precursors of these polyurethanes.

17. Polyamides and copolyamides derived from diamines and dicarboxylic acids, and/or from aminocarboxylic acids, or from the corresponding lactams, for example nylon-4, nylon-6, nylon-6,6, -6,10, -6,9, -6,12, -4,6, -12,12, -11, and -12, aromatic polyamides, e.g. those based on p-phenylenediamine and adipic acid; polyamides prepared from hexamethylenediamine and iso- and/or terephthalic acid and, where appropriate, an elastomer as modifier, e.g. poly-2,4,4-trimethylhexamethyleneterephthalamide or poly-m-phenyleneisophthalamide. Other suitable polymers are block copolymers of the abovementioned polyamides with polyolefins, with olefin copolymers, with ionomers, or with chemically bonded or grafted elastomers; or with polyethers, e.g. with polyethylene glycol, polypropylene glycol, or polytetramethylene glycol. EPDM- or ABS-modified polyamides or copolyamides are also suitable, as are polyamides condensed during processing (“RIM polyamide systems”).

18. Polyureas, polyimides, polyamideimides, polyetherimides, polyesterimides, polyhydantoins, and polybenzimidazoles.

19. Polyesters which derive from dicarboxylic acids and dialcohols and/or from hydroxycarboxylic acids, or from the corresponding lactones, for example polyethylene terephthalate, polybutylene terephthalate, poly-1,4-dimethylolcyclohexane terephthalate, polyhydroxybenzoates, and also block polyether esters which derive from polyethers having hydroxyl end groups; polyesters modified with polycarbonates or with MBS.

20. Polycarbonates and polyester carbonates.

21. Polysulfones, polyether sulfones, and polyether ketones.

22. Crosslinked polymers which derive from aldehydes on the one hand and from phenols, urea or melamine on the other, for example phenol-formaldehyde resins, urea-formaldehyde resins, and melamine-formaldehyde resins.

23. Drying and nondrying alkyd resins.

24. Unsaturated polyester resins which derive from copolyesters of saturated or unsaturated dicarboxylic acids with polyhydric alcohols, and also vinyl compounds as crosslinkers, and also halogen-containing, flame-retardant modifications of these.

25. Crosslinkable acrylic resins which derive from substituted acrylic esters, e.g. from epoxy acrylates, from urethane acrylates, or from polyester acrylates.

26. Alkyd resins, polyester resins, and acrylate resins which have been crosslinked by melamine resins, by urea resins, by isocyanates, by isocyanurates, by polyisocyanates, or by epoxy resins.

27. Crosslinked epoxy resins which derive from aliphatic, cycloaliphatic, heterocyclic, or aromatic glycidyl compounds, e.g. products of bisphenol A diglycidyl ethers or of bisphenol F diglycidyl ethers, which are crosslinked by way of conventional hardeners, e.g. anhydrides or amines, with or without accelerators.

28. Natural polymers, such as cellulose, natural rubber, gelatine, and also their polymer-homologous chemically modified derivatives, for example cellulose acetates, cellulose propionates, and cellulose butyrates and the cellulose ethers, such as methylcellulose; and colophony resins and derivatives.

29. Binary or multiple mixtures (polymer blends) of the abovementioned polymers are also very generally suitable, e.g. PP/EPDM, nylon/EPDM or ABS, PVC/EVA, PVC/ABS, PVC/MBS, PC/ABS, PC/ASA, PC/PBT, PVC/CPE, PVC/acrylates, POM/thermoplastic PUR, PC/thermoplastic PUR, POM/acrylate, POM/MBS, PPO/HIPS, PPO/nylon-6,6 and copolymers, PA/HDPE, PA/PP, PA/PPO, PBT/PC/ABS, and PBT/PET/PC.

The coating compositions in accordance with the invention are advantageously suitable for industrial coating of virtually all parts for private or industrial use, such as radiators, domestic appliances, small metal parts, hub caps or wheel rims. The process of the invention is particularly suited to the production of coated substrates with coatings over basecoats, preferably in the automobile industry. Particularly suitable are coatings over aqueous basecoats based on polyesters, polyurethane resins and amino resins, especially as part of a multicoat paint system.

The coating composition of the invention with a property gradient is preferentially suitable for coating, or as a component of a multicoat paint system. For these coatings and multicoat paint systems, the substrates used are preferably primed or unprimed plastics such as ABS, AMMA, ASA, CA, CAB, EP, UF, CF, MF, MPF, PF, PAN, PA, PE, HDPE, LDPE, LLDPE, UHMWPE, PET, PMMA, PP, PS, SB, PUR, PVC, RF, SAN, PBT, PPE, POM, PUR-RIM, SMC, BMC, PP-EPDM and UP (abbreviations to DIN 7728T1), for example. The plastics to be coated may of course also be polymer blends, modified plastics, or fiber-reinforced plastics. The coating composition of the invention with a property gradient may also be employed for the coating of plastics that are customarily used in vehicle construction, especially motor vehicle construction.

Unfunctionalized and/or nonpolar substrate surfaces may be subjected prior to coating in a known manner to a pretreatment, such as with a plasma or by flaming.

The curing of the applied coating composition is preferably commenced after a certain rest period. The rest period may have a duration of from 30 s to 2 h, preferably from 1 min to 1 h, and in particular from 1 min to 30 min. The rest period is used, for example, for leveling and devolatilization of the clearcoat film and/or for the evaporation of volatile constituents such as solvents, water or carbon dioxide, if the coating composition was applied using supercritical carbon dioxide as solvent. The rest period may be shortened and/or assisted by the application of elevated temperatures up to 80° C., provided this does not entail any alteration (e.g., curing) to the clearcoat. The rest period may, however, also be part of the first cure or may lead directly into the process of the first curing. A distinction is to be made here between the filming of the applied coating composition and its curing. In the context of the present invention, the term “filming” is distinguished from “curing” to the effect that, in the latter, covalent bonds are formed between the components participating in the cure.

In order to achieve the desired gradient in a chemical and/or physical property, the cure is preferably carried out using two different curing mechanisms. One of the two curing methods is preferably directed in such a way that it acts preferentially at the surface and gives the coating material the surface resistance it needs there toward mechanical and environmental influences. Within the coating film, the efficiency of a cure decreases, so that the network formed exhibits an inconstancy in chemical and/or physical properties.

Possible curing methods are the drying and/or evaporation of solutions and dispersions, thermal curing, oxidative curing, or curing by means of high-energy radiation, especially UV radiation. The second cure may take place by one of the curing methods described, e.g., by varying the exposure time or by relatively high temperatures or by relatively high radiative intensities and/or different wavelength ranges of the radiation; preference is given to evaporation and/or drying of solutions or dispersions, particular preference to thermal curing.

The thermal curing has no special features in terms of its method but instead takes place in accordance with the customary and known methods such as heating in a forced air oven or irradiation with IR lamps. Advantageously, thermal curing takes place at a temperature from 50 to 100° C., with particular preference from 80 to 100° C., and in particular from 90 to 100° C., for a period of from 1 second up to 2 h, with particular preference from 5 seconds up to 1 h, and in particular from 10 seconds to 30 min.

Where substrates are used which are able to withstand relatively high thermal loads, thermal crosslinking may also be conducted at temperatures above 100° C. In this case it is generally advisable not to exceed temperatures of 180° C., preferably 160° C., and in particular 140° C.

The extent of the first curing may be varied widely by varying the make-up of the coating composition or by choosing the curing conditions, and is guided by the requirements of the individual case in hand. It may be determined by the skilled worker on the basis of his or her general knowledge of the art and/or on the basis of simple preliminary tests.

In accordance with the invention, the second cure may be effected as an oxidative or thermal cure or as a cure by means of high-energy radiation. The second cure may differ from the first curing method as a result, for example, of variation in exposure time or of relatively high temperatures or of relatively high radiative intensities and/or different wavelength ranges of the radiation. Preferably, the second cure is effected by exposure to high-energy radiation, such as UV radiation in particular.

In the case of curing with high-energy radiation, it is preferred to operate in an atmosphere having a reduced oxygen content. A reduced oxygen content may be ensured, for example, by supplying inert gases, especially carbon dioxide and/or nitrogen, to those surface regions of the clearcoat film that are exposed to the radiation.

Curing with high-energy radiation is carried out using the customary and known radiation sources and optical auxiliary measures. Examples of suitable radiation sources are high or low pressure mercury vapor lamps, with or without lead doping in order to open up a radiation window of up to 405 nm.

The arrangement of these sources is known in principle and may be adapted to the circumstances of the workpiece and the process parameters. In the case of workpieces of complex shape, such as automobile bodies, the regions not accessible to direct radiation (shadow regions) such as cavities, folds and other structural undercuts may be (partially) cured using pointwise, small-area or all-round emitters, in conjunction with an automatic movement means for the irradiation of cavities or edges.

The equipment and conditions for these curing methods are described, for example, in R. Holmes, U.V. and E.B. Curing Formulations for Printing Inks, Coatings and Paints, SITA Technology, Academic Press, London, United Kingdom 1984.

Where the first and second cures take place by actinic radiation, the curings are effected in stages, i.e., by multiple exposure to light or high-energy radiation of different output or with radiation of different wavelengths.

Where the first and second cures take place thermally, the curing operations are conducted in stages, i.e., by precuring or melting using, for example, NIR radiation at low output and/or for a short time, followed by a second cure at higher temperatures and/or for a longer time. The temperature increase per unit time in the coating composition that is to be cured may be continuous or staged, the two cures preferably taking place in accordance with different physical and/or chemical mechanisms, by drying and thermal crosslinking, for example, so that one of the mechanisms does not take place, or only takes place extremely slowly, at low output.

Where the coating film is cured twice differently, the curing operations may be employed simultaneously or with a time stagger. Where different curing methods are used, the sequence may be varied. It is also possible to wait after the first cure before beginning the second cure. In principle, the second cure may also take place only when the coated article is used or while it is in the course of being used.

The skilled worker is able to determine the curing methods and sequence of curing that is most advantageous for the particular case in hand on the basis of his or her general knowledge in the art, where appropriate with the assistance of simple preliminary tests.

One of the two cures is chosen so that, through addition of additives to the coating composition and/or through the choice of curing conditions, an inconstancy results in the chemical and/or physical properties within the coating film perpendicularly to the surface.

In the preferred case, this inconstancy in the chemical and/or physical properties is obtained in the course of an actinic radiation cure. With particular preference, as a result of the addition of suitable UV absorbers and/or colored or colorless pigments to the coating composition, the energy required to activate the photoinitiator drops within the coating film. The drop in light in the wavelength range of the photoinitiator may be effected by absorption and/or scattering. The drop in intensity may be estimated, for example, using the radiation equation of Kubelka-Munk; see Z. W. Wicks, W. Kuhhirt, J. Paint. Technol. 47 (1975) 49-58.

Where the gradient is induced exclusively through the use of at least one UV absorber, said absorber is added to the coating composition in an amount which lies beyond the normal level at which UV absorbers are added to such coating compositions; for example, at least 1% by weight, at least 2% by weight, with particular preference at least 3% by weight, in particular at least 5% by weight, especially at least 7% by weight, based on the overall weight of the coating composition. Examples of preferred UV absorbers are the products available commercially under the following names:

Tinuvin® 384 from Ciba Geigy, a light stabilizer based on isooctyl 3-(3-(2H-benzotriazol-2-yl)-5-tert-butyl-4-hydroxyphenylpropionate,

Tinuvin® 1130 from Ciba Geigy, a light stabilizer based on the reaction product of polyethylene glycol 300 and methyl 3-[3-(2H-benzotriazol-2-yl)-5-tert-butyl-4-hydroxyphenyl]-propionate,

CYAGARD® UV-1164L from Dyno Cytec, a light stabilizer based on 2,4-bis(2,4-dimethylphenyl)-6-(2-hydroxy-4-isooctyloxyphenyl)-1,3,5-triazine, 65% in xylene,

Tinuvin® 400 from Ciba Geigy, a light stabilizer based on a mixture of 2-[4-((2-hydroxy-3-dodecyloxypropyl)oxy)-2-hydroxyphenyl]-4,6-bis(2,4-dimethylphenyl)-1,3,5-triazine and 2-[4-((2-hydroxy-3-decyloxypropyl)oxy)-2-hydroxyphenyl]-4,6-bis(2,4-dimethylphenyl)-1,3,5-triazine, 85% in 1-methoxy-2-propanol,

CGL 1545 from Ciba Geigy, a light stabilizer based on 2-[4-((2-hydroxy-3-octyloxypropyl)oxy)-2-hydroxyphenyl]-4,6-bis(2,4-dimethylphenyl)-1,3,5-triazine,

CYAGARD® UV-3801 from Dyno Cytec, an immobilizable light stabilizer based on triazine, and

CYAGARD® UV-3925 from Dyno Cytec, an immobilizable light stabilizer based on triazine.

The amount of UV absorber or of the UV absorber mixture or of the mixture with colored and colorless pigments depends on the effectiveness of the mixture in question and on the dry film thickness of the coating material. It may be estimated using the Kubelka-Munk equation and other radiation equations, or else determined by the skilled worker on the basis of his or her general knowledge in the art, where appropriate with the assistance of simple preliminary tests.

Since scattering and absorption have little or no influence on actinic radiation curing in the near-surface regions of the coating, there is little or no influence on the resistance of the surface to mechanical and chemical influences.

In the context of this invention, it is not necessary to suppress completely the curing in relatively deep layers of the coating close to the substrate. Rather, it is sufficient to direct the curing in such a way as to improve adhesion. On the particularly preferred plastics substrates, the process described, as well as enhancing adhesion, also prevents the hard and brittle properties at the coating surface influencing the mechanical properties of the plastic.

Preferably, the thickness of the coating film obtained by the process of the invention is at least 10 μm, more preferably at least 20 μm.

The invention additionally provides a coated substrate obtainable by one of the processes described above.

The invention additionally provides a coating composition, as defined above, containing component I) in an amount of at least 1% by weight, preferably at least 2% by weight, with particular preference at least 3% by weight, in particular at least 5% by weight, and especially at least 7% by weight.

The invention is illustrated using the following, nonrestrictive examples.

### EXAMPLES

In the text below, all parts are by weight unless expressly stated otherwise.

The coating compositions were prepared from the components indicated in the implementation examples, with intensive stirring by means of a dissolver or stirrer, unless expressly stated otherwise.

Using the coating compositions described in the implementation examples, a box-type coating bar, gap size 200 μm, was used to produce films on clean, black-colored glass plates. The films were cured on an IST coating unit with 2 UV lamps and a conveyor belt speed of 10 m/min. The radiation dose was approximately 1 800 mJ/cm².

The mechanical stability of the coatings cured at different oxygen contents was determined by means of the König pendulum hardness, DIN 53157, ISO 1522, and by way of the mar resistance by the Scotch-Brite test after storage in a controlled-climate chamber for 24 h. Testing for elasticity or deformation of the films was carried out on standard metal panels to DIN 53156, ISO 1520 (Erichsen cuppling) in each case following storage of the films in a controlled-climate chamber for 24 h.

In the Scotch-Brite test, the test element, a 3×3 cm silicon carbide-modified fiber web (Scotch-Brite SUFN, 3M Deutschland, Del.), is fastened to a cylinder. This cylinder presses the fiber web to the coating with a force of 750 g and is moved over the coating pneumatically. The distance of the deflecion is 7 cm. After 10 and 50 double strokes (DS), respectively, the gloss is measured (six times) in the middle region of the stressed area in analogy to DIN 67530, ISO 2813, at an angle of incidence of 60°. From the gloss values of the coatings before and after mechanical stressing, the difference is formed. The loss of gloss, the delta gloss values, are indirectly proportional to the mar resistance.

In order to characterize the mechanical properties of coated and uncoated plastics substrates, penetration tests (ISO 6603-2: 2000) were carried out. The tests took place under standard climatic conditions at (23±2)° C. and (50±10)% relative humidity, on 10 samples in each case.

Unless specified otherwise, the samples are standard test specimens which were produced from the plastics indicated. Prior to coating, the specimens were wiped with 4:1 isopropanol:water and then coated without further pretreatment.

Coating composition 1: black-pigmented dual-cure-system

| Component | Parts | Remarks |
|---|---|---|
| Isocyanato acrylate | 73.9 | Component 1: |
| (product 6 from the examples | | viscosity about |
| of WO 00/44799) | | 2 Pas |
| Flammruβ 102 | 13.0 | |
| (lamp black; carbon black | | |
| pigment | | |
| from Degussa) | | |
| Dispersing additive | 13.0 | |
| (Disperbyk ® 163 from Byk) | | |
| Butyl acetate | 3.0 | |
| Trimethylolpropane/propanediol | 9 | Component 2: added |
| (weight ratio 2:1) | | to component 1 |
| | | (stock varnish) |
| | | directly prior to |
| | | application and |
| | | cure |
| Photoinitiator mixture | 4.4 | |
| (Irgacure ® 184, Ciba | | |
| Spezialitätenchemie) | | |
| Leveling additive | 0.5 | |
| (Byk ® 307 from Byk) | | |

Curing conditions: 20 min at 80° C. and 4-fold UV exposure at 10 m/min and 80 W/cm

For comparison purposes, an unmodified coating composition, 2, was prepared, which differs from the coating composition 1 of the invention only in the absence of the lamp black pigment. The absence of the lamp black means that, on curing, no gradient is induced in the chemical structure of the coating film.

Both coating compositions result in coatings in which scratching with a fingernail or a wooden spatula leaves no visible damage. The chemical resistance of both coatings meets the specifications of the furniture industry in accordance with DIN 68861, part 1, section 1B.

The results of the penetration test are compared in the table below.

TABLE
Mean value and standard deviations of the results of
testing

| | | | Plastic | Coating | Coating |
|---|---|---|---|---|---|
| | | | without | composition | composi- |
| Substrate | Test | Property | coating | 1 | tion 2 |
| Ultradur ® | Pene- | FM/N | 3479 ± 5 | 3514 ± 12 | 802 ± 117 |
| KR 4080/1 | tra- | WM/J | 25.9 ± 0.8 | 25.8 ± 0.6 | 3.8 ± 1.7 |
| from | tion | WP/J | 42.0 ± 1.5 | 40.0 ± 5.2 | 7.0 ± 3.2 |
| BASF AG | test | | | | |

Key:
FM: maximum force
WM: work done up to maximum force
WP: damage work (on drop of force to 0.5 FM)
Ultradur ® KR 4080/1: PC/PBT/MBS blend

In the penetration test, the influence of the gradient on the resulting coating is clearly evident. There is a reaction here not only in the penetration work but also in the maximum force and therefore also in the work done at maximum force, but only again for the through-cured coating. The coating without through curing has no embrittling influence; the samples behave like the uncoated substrate.

Coating composition 3: UV-absorber-modified
dual-cure coating material

| Component | Parts | Remarks |
|---|---|---|
| Isocyanato acrylate | 73.9 | Component 1: |
| (product 6 from the examples | | viscosity about |
| of WO 00/44799) | | 2 Pas |
| Uvinul ® | 10.0 | |
| (benzophenone-UV absorber | | |
| from BASF AG) | | |
| Dispersing additive | 13.0 | |
| (Disperbyk ® 163 from Byk) | | |
| Butyl acetate | 3.0 | |
| Trimethylolpropane/propanediol | 9 | Component 2: added |
| (weight ratio 2:1) | | to component 1 |
| | | (stock varnish) |
| | | directly prior to |
| | | application and |
| | | cure |
| Photoinitiator mixture | 4.4 | |
| (Irgacure ® 184, Ciba | | |
| Spezialitätenchemie) | | |
| Leveling additive | 0.5 | |
| (Byk ® 307 from Byk) | | |

Curing conditions: 20 min at 80° C. and 4-fold UV exposure at 10 m/min and 80 W/cm

For comparison purposes, an unmodified coating composition, 4, was prepared, which differs from the coating composition 3 of the invention only in the absence of the UV absorber. The absence of the UV absorber means that, on curing, no gradient is induced in the chemical structure of the coating film.

TABLE
Film properties for coating compositions 3 and 4

| Test | Coating composition 3 | Coating composition 4 |
|---|---|---|
| Erichsen cupping | 5.5 | 4.5 |
| Pendulum hardness | 183 | 193 |
| Mar resistance | 89 | 88 |

Comparison of the mechanical properties of uncoated plastics substrates and specimens coated with coating composition 3 in accordance with the invention, and 4 (comparative).

The results of the penetration test are compared in the table below.

TABLE
Mean values and standard deviations of the results of
testing

| | | | Plastic | Coating | Coating |
|---|---|---|---|---|---|
| | | Measurement | without | compo- | composi- |
| Substrate | Test | temperature | coating | sition 3 | tion 4 |
| Stapron ® | Penetration | 23° C. | 69 | 27 Nm | 29 Nm |
| from | test | 0° C. | 70 | 24 Nm | 12 Nm |
| BASF AG | | | | | |
| Luran ® | Penetration | 23° C. | 78 | 51 Nm | 44 Nm |
| SC from | test | 0° C. | 76 | 45 Nm | 21 Nm |
| BASF AG | | | | | |

Stapron ®: ABS/PA6 blend
Luran ® SC: PC/ASA blend

We claim:—

1. A process for producing a coated substrate by applying at least one coating composition to the substrate and then curing to obtain a coating film on the substrate, which comprises inducing and fixing in the coating composition a gradient in at least one chemical and/or physical property, substantially perpendicularly to the substrate surface.

2. A process as claimed in claim 1, wherein the property attributing the gradient is selected from the crosslinking density, network arc length, network tension, microhardness, free volume, and combinations thereof.

3. A process as claimed in either of claims 1 and 2, wherein the gradient is induced during application of the coating composition to the substrate and fixed during cure.

4. A process as claimed in either of claims 1 and 2, wherein the gradient is induced after application of the coating composition to the substrate and fixed during cure.

5. A process as claimed in either of claims 1 and 2, wherein the gradient is induced and fixed during cure.

6. A process as claimed in any of the preceding claims, wherein a coating composition is used which can be cured by at least two different mechanisms.

7. A process as claimed in claim 6, wherein the coating composition can be cured with UV radiation and thermally.

8. A process as claimed in claim 7, wherein the coating composition comprises
A) at least one compound containing at least two functional groups which are capable of reaction with a complementary functional group of a compound of component B) under conditions of thermal cure,
B) at least one compound containing at least two functional groups which are capable of reacting with a complementary functional group of a compound of component A) under conditions of thermal cure,
C) if desired, at least one compound having two C═C double bonds curable with UV radiation in the presence of a photoinitiator,
D) at least one photoinitiator,
E) if desired, at least one compound capable of forming free radicals thermally,
F) if desired, at least one reactive diluent, other than the compounds of components A) to C) which is capable of crosslinking under conditions of thermal cure,
G) if desired, at least one reactive diluent, other than the compounds of components A) to C) and F), which is capable of crosslinking with UV radiation,
H) if desired, nanoparticles,
I) at least one coating additive which is capable of inducing the gradient during cure, and
K) if desired, further customary coating additives other than compounds of component I),
with the proviso that at least one compound of components A) and/or B) additionally contains at least one UV-curable C═C double bond or the coating composition mandatorily includes at least one compound of component C).

9. A process as claimed in claim 8, wherein component I) is selected from UV absorbers, colorless and colored pigments, and mixtures thereof.

10. A process as claimed in either of claims 8 or 9, wherein the coating composition contains component I) in an amount of at least 1% by weight, preferably at least 5% by weight, based on the overall amount of components A) to K).

11. A process as claimed in any of the preceding claims, wherein the thickness of the coating film is at least 10 μm, preferably at least 20 μm.

12. A coated substrate obtainable by a process as claimed in any of claims 1 to 11.

13. A coating composition as defined in claim 8, containing components I) in an amount of at least 1% by weight, preferably at least 5% by weight.
